(19) United States
(12) Patent Application Publication
(10) Pub. No.: US 2017/0322555 A1
(43) Pub. Date: Nov. 9, 2017

(54) Autonomous Postal Delivery System for Conventional Mailboxes

(71) Applicants: dragan nikolic, holiday, FL (US); aurelia nikolic, holiday, FL (US)

(72) Inventors: dragan nikolic, holiday, FL (US); aurelia nikolic, holiday, FL (US)

(73) Assignee: Dragan Nikolic, holiday, FL (US)

(21) Appl. No.: 15/598,283

(22) Filed: May 17, 2017

(51) Int. Cl. G05D 1/00; G05D 1/02; B25J 9/14; G01S 17/93

(52) U.S. Cl. CPC G05D 1/0088; G05D 1/0231; B25J 9/144; G05D 1/0257; G01S 17/936; G05B 2219/45047; G05D 2201/0213

(57) ABSTRACT

An autonomous postal delivery systems for conventional mailboxes is disclosed. A self-driving vehicle with LIDAR sensors in conjunction with GPS algorithms guides the mail delivery van safely to predetermined addresses. Onboard optical scanners recognize residential mailboxes and robotic systems retrieve mail from secured compartments and deliver mail efficiently. An objective of the invention is to automate postal deliveries to residential mailboxes using unmanned vehicles.

### FIELD OF THE INVENTION

The present invention generally relates to mail delivery systems. More specifically, this invention relates to autonomous postal delivery systems for conventional mailboxes.

### BACKGROUND

Postal delivery services have been found to date back to Roman times. As roadways were developed, many parcels were delivered by horse and buggy. With the advent of the train and airplane, delivery efficiencies improved rapidly. Today, much of the mail is delivered by couriers and postal workers via vans and specialized shuttles. A few countries have begun experimenting with autonomous vehicles for postal delivery in places such as Sweden and France. To fulfill the dream of truly autonomous postal delivery, researchers have begun patenting such systems. U.S. Pat. Nos. 9,256,852B1 and 9,256,852B1 granted to Myllymaki and WO2016132239A1 granted Norton disclosed autonomous vehicles having secured compartments accessible to customers who request a delivery. United States Patent No. 20140081445A1 granted to Villamar disclosed a systems of robots that load and deliver parcels using a dedicated, rail-based transport vehicle. U.S. Pat. Nos. 9,523,986 B1 and 9,523,986B1 granted to Steer and Abede respectively, disclosed aerial autonomous drone delivery systems. And United States Patent No. US2015379468A1 granted to Harvey disclosed a two-part vehicular system whereby a large, autonomous highway vehicle hands off a parcel to a small local autonomous transport carriage for final delivery. While many of these autonomous vehicle systems address commercial deliveries of large parcels, few were found in the prior art that specialized in the interaction with conventional, residential mailboxes.

### SUMMARY OF THE INVENTION

The device herein disclosed and described provides a solution to the shortcomings in the prior art through the disclosure of an autonomous postal delivery systems for conventional mailboxes. An object of this invention is to automate residential postal delivery services.

Another object of the invention is to provide an autonomous vehicle to transport mail items to such mail boxes. The vehicle is comprised of a driverless van powered by onboard batteries and controlled by an onboard computer. The vehicle is guided along public roadways by several, onboard Light Imaging, Detection, and Ranging (LIDAR) sensors that utilize lasers to detect objects in the vicinity. Laser data is then paired with global positioning systems (GPS) to obtain an accurate picture of the surroundings such that it will arrive at destinations safely. Preprogrammed mail route lists are downloaded into the van's controller unit allowing the vehicle to deliver mail at select addresses.

Another object of the aforementioned invention is to provide optical scanners and/or Radio Frequency Identification (RFID) to recognize exact mailbox locations in order to properly position the vehicle. Optical sensors also determine whether or not a pickup is needed based upon recognizing the mailbox flag position. An algorithm built into the controller software compares the image observed with a database of thousands of similar mailboxes to make a determination.

Another object of the aforementioned invention is to provide an automated, mail sorting system within the vehicle. Once an address and mailbox are recognized, a window unlocks from the vehicle and a robotic arm (controlled by the main controller) opens the mailbox. Any incoming mail to be picked up is retrieved by the robotic arm and is temporarily set aside in the vehicle. Residential addresses are linked with a plurality of secure compartments within the van. A plurality of stepper motors and small control grippers along moving vertical and horizontal rails and allow outgoing mail to be retrieved from the compartments and placed onto a conveyor belt along the floor of the vehicle. Pre sorted mail inside each compartment is placed into dedicated cylinders in the compartments at the mail facility before the route begins. Once the cylinders in the vehicle compartments are retrieved by the grippers, they are placed on a conveyor at the floor of the vehicle and are sent to the large, main robotic arm and gripper at the head of the vehicle (also governed by the controller) where it retrieved and placed into the mailbox. The mailbox is then closed (the flag is rotated if needed) and the window to the vehicle is secured. Incoming mail is then sent back to the appropriate compartment by the conveyor and gripper systems.

Another object of the invention is to provide a ‘point-of-delivery-apparatus’ system whereby mail is inserted inside of a mailbox using the robotic arm with a cylinder and piston apparatus. A piston is positioned at the rear of the cylinder and an aperture (also at the rear of the cylinder) is configured to accept a plunger rod that extends from the robotic arm. The arm then extends the rod into the cylinder, makes contact with the piston such that the mail is carefully expelled into the mailbox. The cylinder is then returned to the vehicle and the robotic arm closes the mailbox door (the flag is rotated if needed) and the window to the vehicle is secured.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 is a perspective view of the invention.

FIG. 2 is a top view of the invention.

FIG. 3 is a section view of the invention.

FIG. 4 is a section view of the robotic arm and cylinder placing mail inside a mailbox.

FIG. 5 is a flow diagram of the delivery function method.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

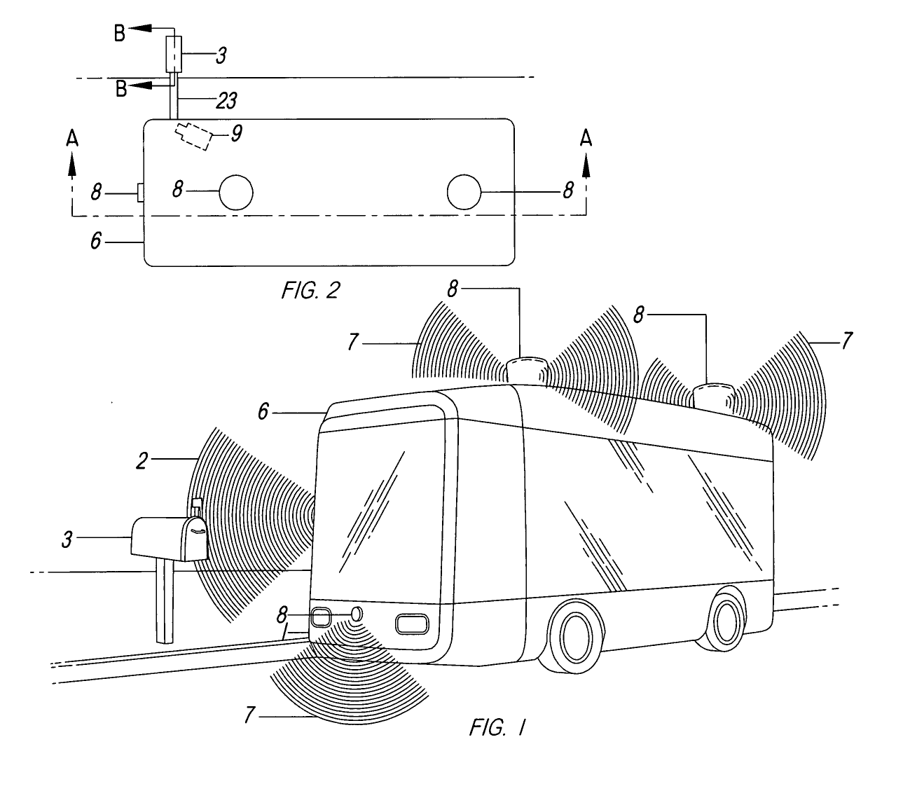

FIG. 1 showing a perspective front view of autonomous delivery vehicle 6 having a plurality of visual sensors 8 disposed at several sides of said vehicle 6 including the uppermost surface and front bumper area 1. Sensors may be comprised of rotating LIDAR units that broadcast a series of laser points 7 that return to the sensor, sent to the main controller and are interpreted to prevent collisions. Said sensors comprised of systems such as those by Velodyne™ and used in Google™ autonomous vehicles thereon.

FIG. 2 showing a top view of autonomous delivery vehicle 6 stopped at a mailbox 8. Onboard mailbox sensor 9 detecting conventional residential mailbox 3 comprised of an optical scanner and/or RFID and the like. Signals from said sensor 9 being used by the vehicle main controller to determine elevation of said box 3 and position the vehicle in a manner such that mail can be transferred from vehicle 6 to said box 3.

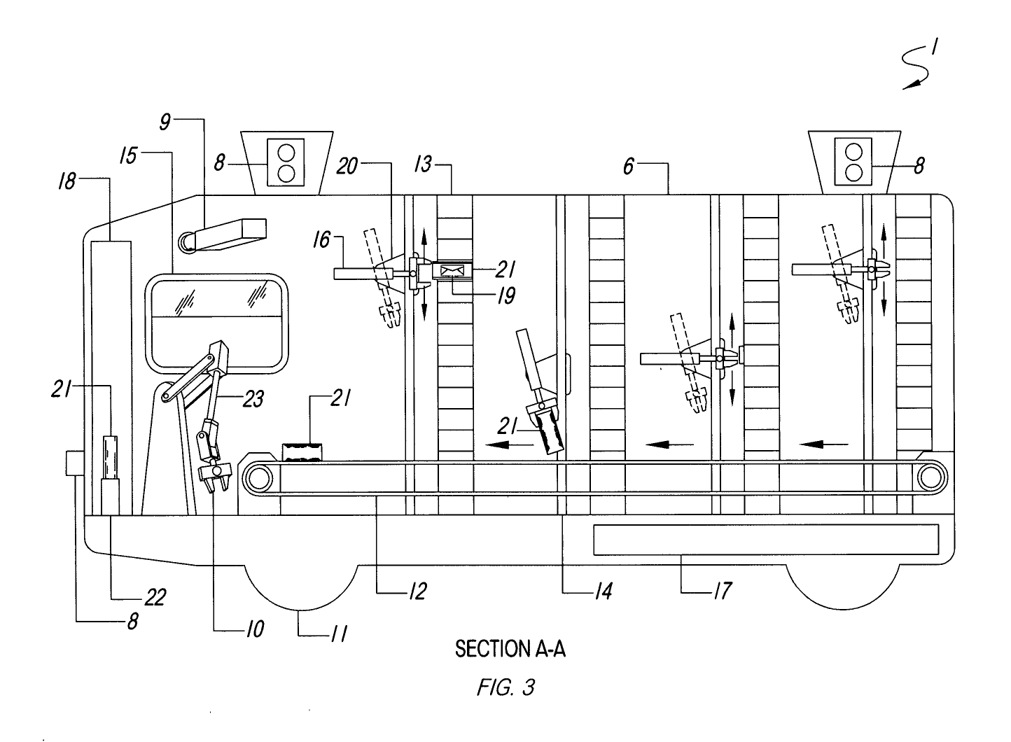

FIG. 3 showing a section view of autonomous vehicle 6 having mailbox camera detector 9 affixed thereto and window 15 with a selectively, upwardly-sliding window governed by main controller unit 8 allowing robot arm 23 with gripper 10 (located on one end of said vehicle 6) to transfer mail items to the exterior of said vehicle 6 therein. Said robot arm 23 also being comprised of servo motors allowing said arm 23 to articulate in all directions. Conveyor 12 comprised of a flexible belt, such as rubber etc., being disposed below mail compartments 13 and looped around two rollers with motors connected to said controller 18. FIG. 3 showing horizontal and vertical gantries 14 being adapted along mail compartments 13 allowing robotic grippers 16 to be moved to infinite positions among said mail compartments 13. Said grippers 10 having servo motors allowing them to control grips based on instructions from said main controller 18. FIG. 3 also showing battery assembly 17 configured along a terminal end of said vehicle 6's floor comprised of lithium or nickel hydride etc. cells.

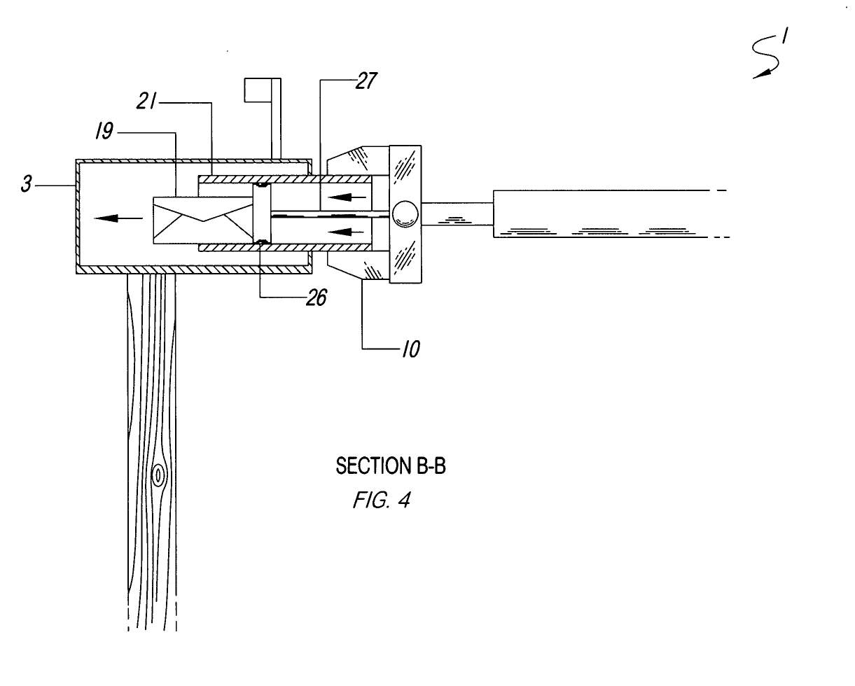

FIG. 4 showing a section view of conventional residential mailbox 3 having gripper 10 inserting mail cylinder into said mailbox 3. Cylinder 21 comprised of a hollow cylinder made of a rigid material such as aluminum and the like and having a rigid, cylindrical plunger 26 made of plastic etc. therein. Said plunger 26 configured perpendicular to said cylinder 21's longitudinal axis and affixed to proximal rod 27 being operatively secured to said robotic arm 10 and being governed by commands from said controller 18.

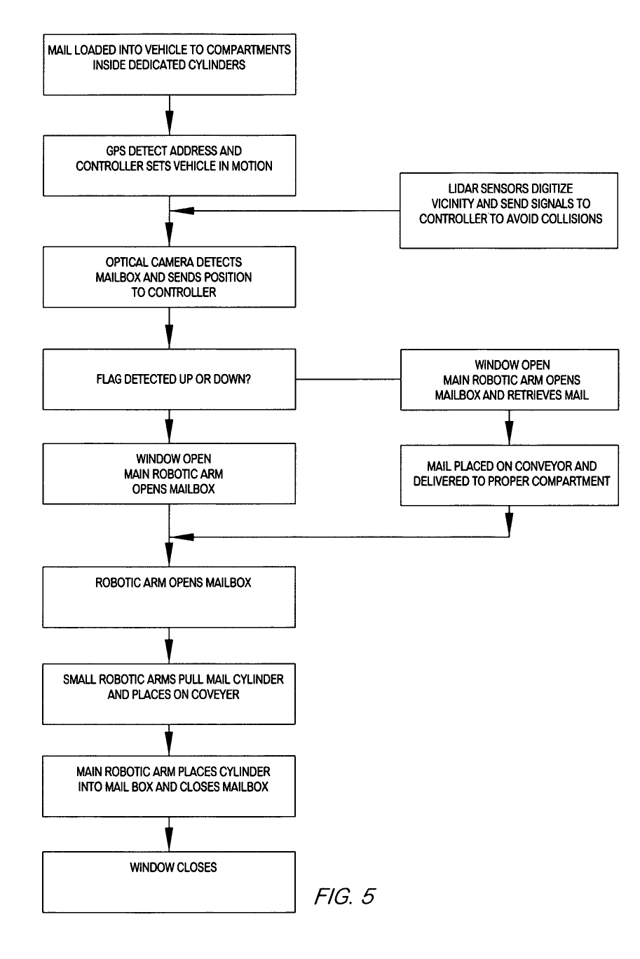

FIG. 5 showing a flow diagram of methods associated with the delivery of mail in conventional mailbox 3 using aforementioned autonomous vehicle 6.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. An autonomous postal delivery systems for conventional mailboxes.

2. The device of claim one providing an automated residential postal delivery service.

3. The device of claim one providing an autonomous vehicle to transport mail items to such mail boxes.

4. The device of claim one providing optical or radio frequency scanners to recognize exact mailbox locations in order to properly position said autonomous vehicle.

5. The device of claim one providing an an automated, mail sorting system within said autonomous vehicle.

6. The device of claim one providing an a ‘point-of-delivery-apparatus’ system whereby mail is inserted inside of a mailbox using the robotic arm with a cylinder and piston apparatus.
